(19) United States
(12) Patent Application Publication
(10) Pub. No.: US 2020/0046049 A1
(43) Pub. Date: Feb. 13, 2020

(54) Illuminated Glow Jacket

(71) Applicant: Michael J. Benz, Los Angeles, CA (US)

(72) Inventor: Michael J. Benz, Los Angeles, CA (US)

(21) Appl. No.: 16/059,444

(22) Filed: Aug. 9, 2018

(51) Int. Cl. A41D 27/08; A41D 1/02; A41D 27/20; A41D 1/00; F21V 33/00; F21V 23/02

(52) U.S. Cl. CPC A41D 27/085; A41D 1/02; A41D 27/20; F21Y 2115/20; F21V 33/0008; F21V 23/023; A41D 2300/322; A41D 1/005

(57) ABSTRACT

The invention relates to a jacket assembly consisting of EL PANEL light embedded on the front and back panel of the jacket where jacket has 3 functions while glowing, including solid, strobe and flashing mode which is powered by a small power unit that requires 2 AA batteries. The power pack is located inside of jacket lining in a small pocket

### BACKGROUND

### Field of the Invention

The present invention relates to a clothing or an outer garment or more particularly related a glowing jacket consisting of EL PANEL technology on front or back of jacket. The invention, substitutable for conventional jackets, which will provide further style, more comfort, and aesthetic satisfaction for the user without compromising the functionality of jackets.

### Description of the Related Art

Every year, buyers spend millions of dollars purchasing “external wearables”. Each wearable claim to provide a customized fit. However, previously designed wearables typically overpromise and fail to deliver what is best suited for customers and beneficial for them in long term.

When it comes to jackets, whether it's a chic leather jacket for hitting the best clubs or a more traditional conservative design there's an assortment of looks and technology available, there is a jacket to suit every one's taste for style or need for functionality. The array of looks and technologies that jackets offer can be dizzying, though. Jackets can be waterproof, windproof, or insulated. They can vary in length, feature a hood or a collar. Jackets can also be cut in various ways to fit differently on a man's body and express different aesthetics. Some jackets are more appropriate for business wear, while others are designed for specific sporting events or looking good on the street.

But nobody promises that the jacket you are buying will fit you well and look good on you. Everyone wants to look different and wear something that is new into the market. The use of EL PANEL technology in today's fast-growing world is evident. The current invention proposes a jacket that uses EL PANEL technology on front and back panel to provide the illuminated glowing panel to user.

There are multiple inventions that have been registered in prior art that focus on providing jackers. For instance According to U.S. Pat. No. 5,201,075 issued to Ronald J. Svetich on 1992 Sep. 4 displays an Athlete's arm jacket which includes a first shell portion for covering one side of the upper torso of a person wearing the jacket. A sleeve is secured to the shell portion for covering one arm. A mesh covers the opposite side of the upper torso, and a second shell portion is detachably secured to the first shell portion. Another sleeve is attached to the second shell portion. The jacket may be worn and used as a traditional jacket, or one shell portion may be detached so that only one arm, shoulder and one side of the upper torso of the body are covered. However, this invention doesn't explain how people with different body structures will wear the jacket and how comfortable it will be for them.

According to U.S. Pat. No. 2,004,019,997,6 issued to Juliana Hunt in 2003-04-10 a jacket that may be used in hot weather is disclosed. The jacket may be particularly useful for motorcycle and equestrian riders. The jacket is sufficiently fashionable and stylish such that it may be worn on other occasions as well. According to some aspects the jacket includes two sleeves, a chest portion, and a back portion. The chest portion is shorter than conventional jackets, and according to some arrangements the chest portion is designed to accent a woman's figure and be worn above the wearer's breast line. A zipper, snaps, buttons, or Velcro, and/or decorative trim may also be added. Similarly, this jacket is also for creating fashion statement but its fit to everyone's unique body structure is still a question.

A U.S. Pat. No. 2,012,016,489,8A1 Glow-in-the-Dark Life Jacket issued to Mckinney Paden depicts an architecture that provides a glow in the dark flotation device that increases the likelihood of quickly locating individuals lost in water by increasing the visibility of the user, and more particularly to a durable conventional life jacket having a phosphorescent portion that emits visible light under low-light conditions.

A Safety glow vest and jacket bearing U.S. Pat. No. 3,561,394A issued to George R Pickens discloses a garment for riders of motor cycles, bicycles or motor scooters, the garment having a material that will glow when the headlights of an automotive vehicle shine toward it, thus giving the motorist a visibly clear indication of the presence of the cyclist ahead so to prevent colliding into him.

A U.S. Pat. No. 7,147,339B2 EL is a lighted garment with reduced glow up is issued to Safe Lites LLC. The invention discloses a safety vest which is sized to be worn by a human, wherein the vest has a front and back and left and right sides each having a shoulder portion. An EL strip is provided on each side of the vest extending from the bottom of the vest upwards toward the shoulder portion. A power source is supported by the vest and connected to the EL lamp strips to supply electrical energy to the strips so that they emit EL light, wherein the EL light emitted by the EL strip is a safety yellow color, and wherein other portions of the vest are a safety orange color. Further safety articles of clothing and devices are also described.

Our invention discloses a Jacket with “illuminated glowing panel” on front or back of jacket or any other article of clothing. The Jacket will have 3 functions while glowing, first is solid, strobe and flashing mode and is powered by a small power unit that requires 2 AA batteries.

None of the previous inventions and patents, taken either singularly or in combination, seem to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is an important object of the present invention to provide extreme flexibility and adaptability of the garment as per every wearer's unique body shape and for many different portions of the body or different sets of body muscles

It is the general object of current invention to provide a jacket with EL PANEL technology having glowing panels at front and back of the jacket.

It is the object of the current invention to provide a jacket to best fit according to the shape and size of the individual wearing it.

It is also the object of the current invention to provide a jacket with 3 functions while glowing i.e. solid, strobe and flashing mode.

It is the object of the current invention to provide a power source by a small power unit that requires 2 AA batteries.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Jacket is a garment that can help you withstand the cold, wind, and snow or rain. It contains thick insulation so that your body stays warm even when not in motion. The thinner insulated layers are often part of an integrated system of layers, to give the user ultimate discretion in warmth and perspiration management when used during winter activities.

A good winter jacket needs to keep you and the insulation dry and should have a waterproof/breathable outer shell. Besides being functional in a cold environment, these jackets also tend to have a longer cut and more attention to how they will look on casual or more formal occasions. In contrast to their lightweight counterparts used for cold weather sports, casual models often include many more features that add to their comfort and liveability, since weight is not a primary consideration.

With all the requirements and sky-high prices how much these jackets are as per the requirements. Wearing the jacket at the top can be a final style statement. Currently there are standard Utility Jackets and Vests in the fashion marketplace. Primary use of any jacket is to form a protective outer covering for the end user, but what if it adds up better style to one's personality

Keeping in view the utility of jackets and vests and every individual's personality, the current invention is devised with a technology that utilizes the EL PANEL technology to provide the illuminated glow panel on the front and back side of the jacket.

In one embodiment of the invention the assembly of jacket is similar to a normal jacket where a jacket with “illuminated glowing panel” on front or back of jacket is disclosed. The jacket provides three main functions while glowing. These functions include solid, strobe and flashing mode. These modes allow the user to set the jacket

Further an additional embodiment of the invention is that the jacket will provide the comfort while simultaneously remaining lightweight and durable for the end user.

In the additional embodiment of the invention the EL PANEL assembly is powered by a small power unit that requires 2 AA batteries. The power pack is located inside of jacket lining in a small pocket.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE DRAWINGS

Embodiments of the present invention will now be described, by way of example only, and with reference to the accompanying drawings, in which:

FIG. 1 illustrates an EL PANEL light at backside of the jacket, in accordance with embodiments of the invention;

FIG. 2 shows the embedded EL PANEL technology and its electronic system in accordance with the embodiments of the invention;

FIG. 3 shows the complete front jacket in accordance with the embodiments of the invention;

FIG. 4 shows the closed view of the front side of the jacket in accordance with the embodiments of the invention;

FIG. 5 shows the back view of the jacket in accordance with the embodiments of the invention

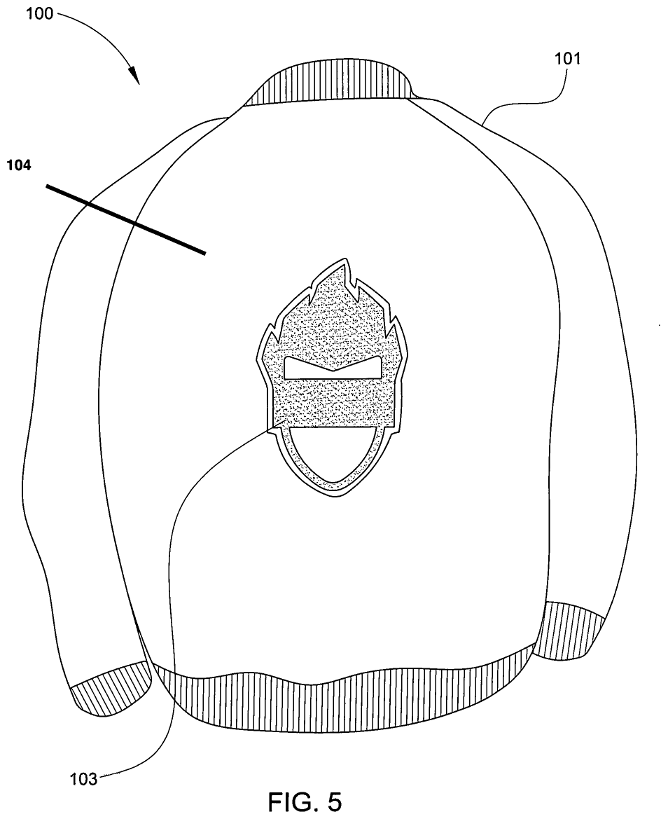

### DETAILED DESCRIPTION OF THE DRAWINGS

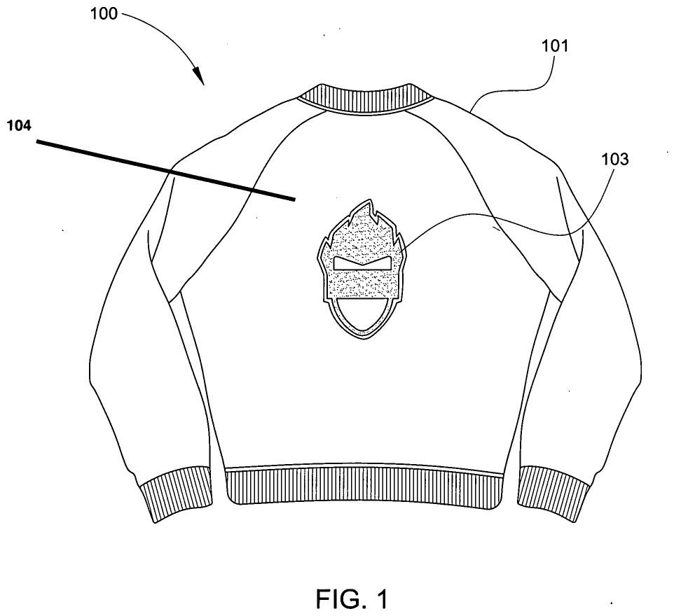

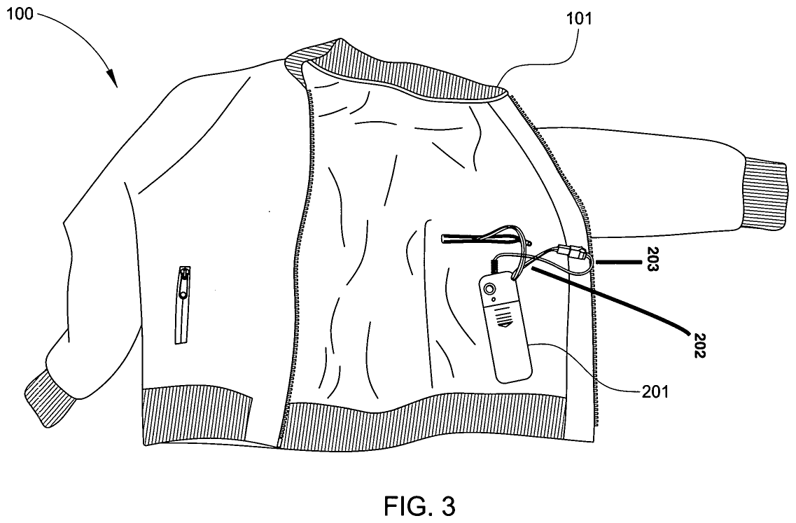

Referring to the figures, there are shown several embodim-ents of the invention, FIG. 1 comprises 100 a jacket as shown in FIGS. 1, 3 4 and 5. 101 comprises body of the Jacket. 103 comprises a glowing LED. The back surface 104 is the complete area of the backside of the jacket, 103 is attached on the surface of 104 as shown in the embodiments of the invention in FIG. 1.

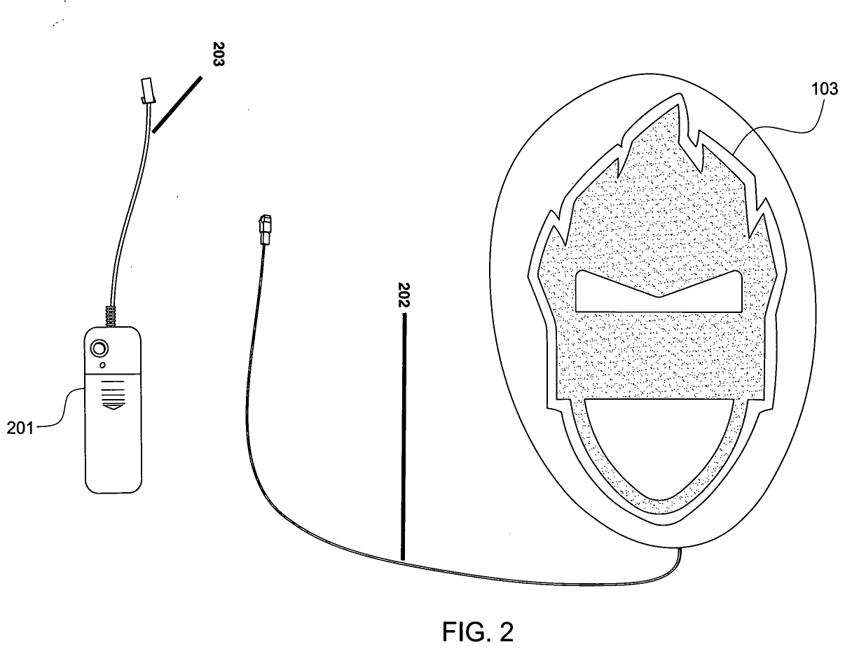

Referring to FIG. 2 of the embodiment of the invention, 103 is the EL PANEL glowing light fixed on the backside of the jacket 104 shown in FIG. 1, 202 attached with 103 as electronic wire which fixes with 203 which completes the electronic circuit to help in glow the EL PANEL103. 201 is the battery function of the EL PANEL103.

Referring to FIG. 3, 101 is the body of the jacket, 201 is placed within the body of jacket 101 and 100. 202 attached with 203 to further complete the EL PANEL electronic circuit which support the EL PANEL light for glowing.

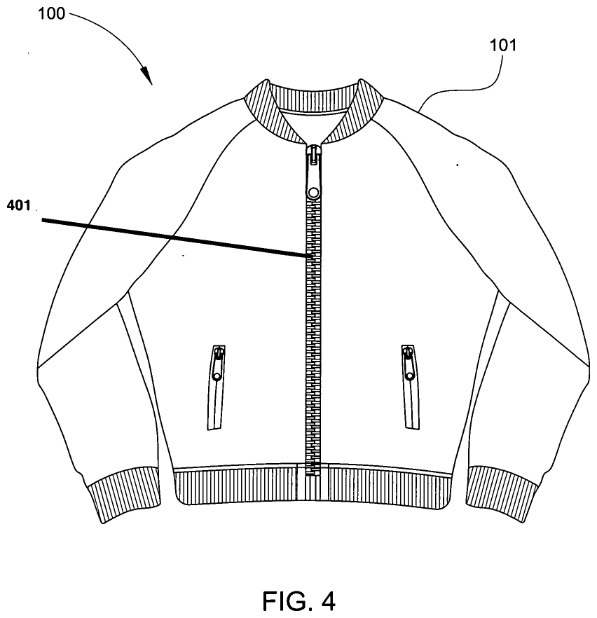

Referring to FIG. 4, 401 is the Zipper of the jacket body 100 and 101 which helps in closing both sides of the jacket body. The EL PANEL 103 further attached with the jacket backside surface 104.

As will be appreciated, there are many different configurations that would fall within the embodiments of the present invention and the above embodiments are described by way of example only. Many variations are possible without departing from the scope of the invention as defined in the appended claims.

1: A jacket with embedded EL PANEL light display comprising:
In a garment of a class described, a body part opens at the front which can be closed by a zipper and having neck and arm openings, a sleeve and shoulder part comprising front sections having their upright edges spaced apart, said sleeve and shoulder part fitting over the upper portion of the body part with a padded elbow. An exterior portion displaying illuminated glowing panels on the front and back side whereas the inner portion consisting of a Power pack is located inside a jacket lining in a small pocket for the smooth and comfortable movement and comfort for the wearer.

2. A jacket with embedded EL PANEL technology where according to claim 1, the LED's are fixed on the front and back side of jacket allowing three modes including solid, strobe and flashing mode.

3. A jacket with embedded EL PANEL technology where according to claim 1, a body part opens at the front of the jacket and provided with suitable fastening means for closing the jacket front, said body part having neck and arm openings, a sleeve and shoulder part fitting over the upper portion of the body part.

4. A jacket with embedded EL PANEL technology where according to claim 1, a waist buckle that runs along the lower edge of jacket and can be used to create more of a settled fit.

5. A jacket with embedded EL PANEL technology where according to claim 1, a single zipper according to claim 1, which runs down the center of coat, cinching the panels together when it's pulled up.
